(19) United States
(12) Patent Application Publication
(10) Pub. No.: US 2026/0270206 A1
(43) Pub. Date: Sep. 10, 2026

(54) SYSTEMS AND METHODS FOR BANDWIDTH AWARE ADMISSION CONTROL IN HYBRID 5G-AD HOC NETWORKS

(71) Applicant: VERIZON PATENT AND LICENSING INC., Basking Ridge, NJ (US)

(72) Inventors: Suresh Koneri CHANDRASEKARAN, Chennai (IN); Debanik DEY, Bengaluru (IN)

(73) Assignee: VERIZON PATENT AND LICENSING INC., Basking Ridge, NJ (US)

(21) Appl. No.: 19/074,616

(22) Filed: Mar. 10, 2025

(51) Int. Cl. H04L 47/127

(52) U.S. Cl. CPC H04L 47/127

(57) ABSTRACT

Disclosed are systems and methods that provide a computerized framework for a decision intelligence (DI)-based bandwidth forecasting framework that provides proactive network management. By leveraging advanced artificial intelligence and/or machine learning (AI/ML) models, the disclosed framework can analyze historical network traffic patterns alongside current conditions to predict future bandwidth availability with high accuracy. Such predictions can be leveraged to anticipate potential congestion points (e.g., seconds, minutes or hours) before they materialize, providing crucial time for preventive measures. Indeed, the framework can operate to mitigate, configure, stop and/or modify network traffic, connections, requests and/or policies to avoid any network degradation that the framework predicted to ensure network stability during demand surges can be handled while ensuring fair resource allocation among users.

### BACKGROUND INFORMATION

Network congestion, for example in fifth generation (5G) networks, arises when the volume of data transmitted surpasses the network's capacity to handle it efficiently. This can lead to delays, packet loss and degraded performance, among other technical shortcomings, which can impact user experience and service quality.

### BRIEF DESCRIPTION OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIGS. 1A and 1B are block diagrams of example network architectures according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 provides an example results-based operation of network optimization according to some embodiments of the present disclosure;

FIG. 5 illustrates a non-limiting example embodiment of a network architecture according to some embodiments of the present disclosure; and

FIG. 6 is a block diagram illustrating a computing device showing an example of a client or server device used in various embodiments of the present disclosure.

### DETAILED DESCRIPTION OF EXAMPLE EMBODIMENTS

Hybrid 5G-Ad hoc networks provide a dynamic network architecture that combines the reliability of infrastructure-based 5G systems with the flexibility of ad hoc networking. Current 5G-Ad hoc networks, however, face technical shortcomings in bandwidth management that can severely impact performance. One challenge is the unpredictable nature of bandwidth demand, which can spike dramatically and without warning. When these surges occur, current implementations and/or configurations of such network infrastructures struggle to adapt quickly enough, resulting in congestion, connection drops, and degraded quality of service.

Traditional admission control mechanisms exacerbate this problem through their fundamentally reactive approach. Such systems typically wait until congestion occurs before taking action, responding to problems rather than preventing them. In fast-changing 5G-Ad hoc environments, this reaction time creates a critical delay during which user experience significantly deteriorates. Furthermore, conventional systems operate on relatively simplistic threshold-based rules that fail to capture the complex dynamics of modern hybrid networks, especially when devices rapidly join and leave the network or when environmental conditions change.

To that end, according to some embodiments, the disclosed systems and methods provide a decision intelligence (DI)-driven bandwidth forecasting framework that addresses such shortcomings, among others, by shifting from reactive to proactive network management. By leveraging advanced artificial intelligence and/or machine learning (AI/ML) models, the disclosed framework can analyze historical network traffic patterns alongside current conditions to predict future bandwidth availability with high accuracy. Such predictions can be leveraged to anticipate potential congestion points (e.g., seconds, minutes or hours) before they materialize, providing crucial time for preventive measures.

According to some embodiments, as discussed herein, the disclosed framework can function via integration of multiple data streams, including, for example, real-time network telemetry, user mobility patterns, application usage profiles, and environmental factors. Deep learning models, particularly recurrent neural networks with attention mechanisms, can process such multidimensional data to identify complex temporal patterns invisible to traditional algorithms. As discussed herein, the framework can then generate probabilistic forecasts of bandwidth availability across different network segments and timeframes.

Accordingly, in some embodiments, with such predictions, the framework can function to apply and activate admission control mechanisms that can dynamically adjust traffic, connections and/or its policies before congestion occurs. For example, when the framework forecasts an imminent bandwidth shortage in a particular network segment, the framework can operate to temporarily restrict new high-bandwidth connections to that segment, reroute traffic through alternative paths, and/or negotiate quality of service parameters with existing connections. Such proactive approach maintains network stability during demand surges and ensures fair resource allocation among users.

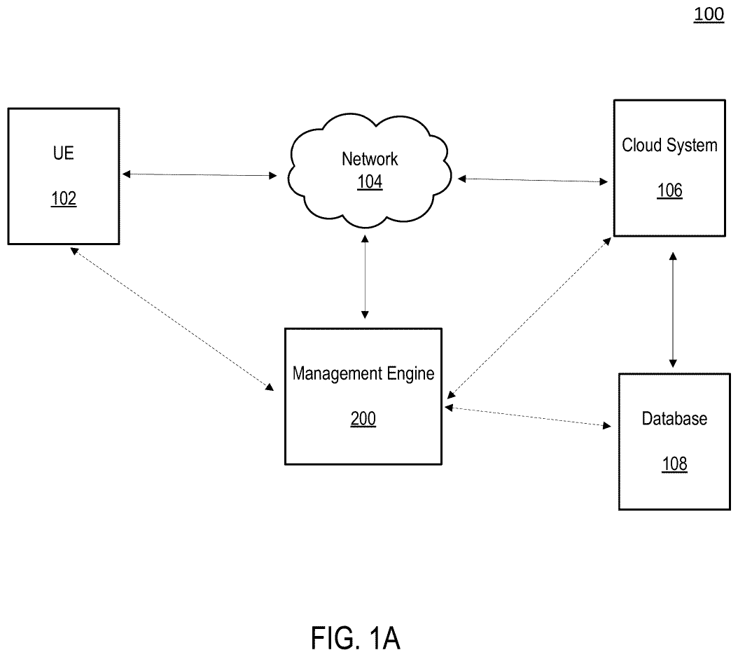

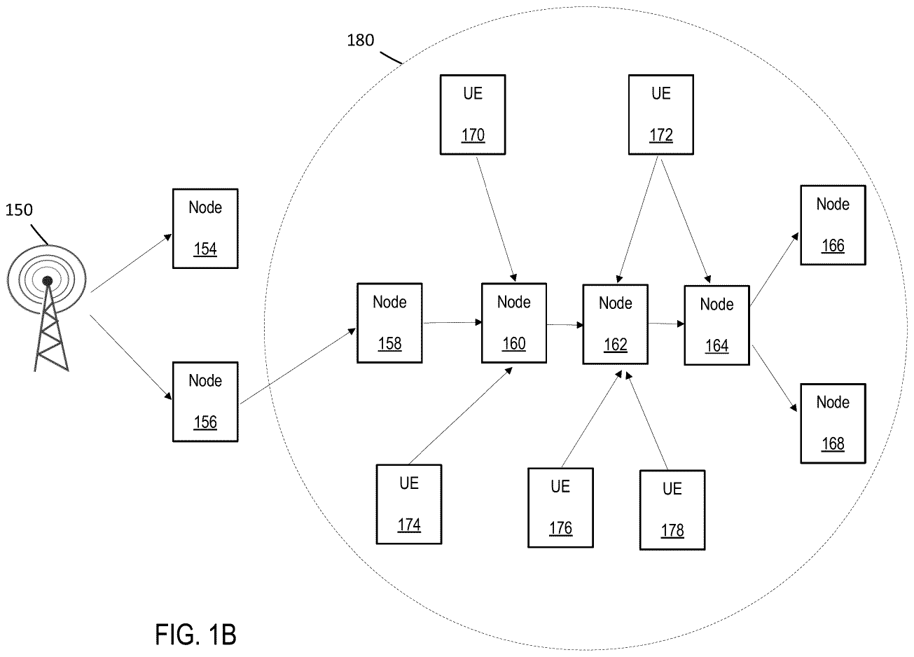

With reference to FIG. 1A, system 100 is depicted which includes user equipment (UE) 102, network 104, cloud system 106, database 108, and management engine 200. It should be understood that while system 100 is depicted as including such components, it should not be construed as limiting, as one of ordinary skill in the art would readily understand that varying numbers of UEs, engines, cloud systems, databases and networks can be utilized; however, for purposes of explanation, system 100 is discussed in relation to the example depiction in FIG. 1A.

According to some embodiments, UE 102 can be any type of end-device operated in a mobile wireless network. For example, UE 102 can include, but not be limited to, a mobile phone, tablet, laptop, Internet of Things (IoT) device, wearable device, an autonomous guided vehicle (AGV), autonomous mobile robot (AMR), unmanned aerial vehicle (UAV), and/or any other type of device.

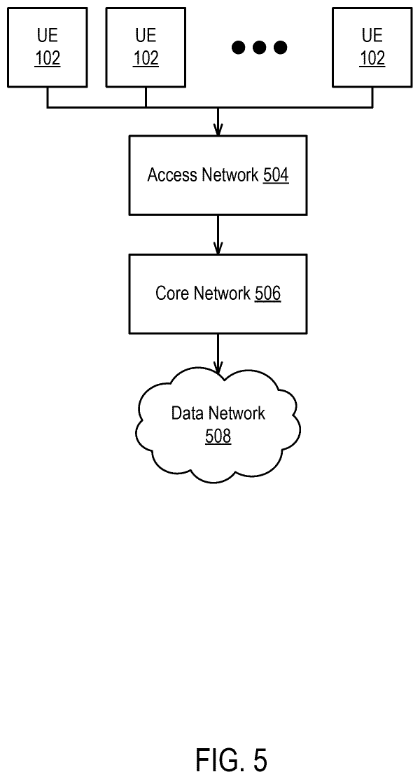

In some embodiments, network 104 can be any type of network, and can facilitate connectivity of the components of system 100, as illustrated in FIG. 1A. Further discussion of embodiments of network 104 are provided below with reference to FIG. 5.

According to some embodiments, cloud system 106 may be any type of cloud operating platform and/or network-based system upon which applications, operations, and/or other forms of network resources may be located. For example, cloud system 106 may be a service provider and/or network provider from where services and/or applications may be accessed, sourced or executed from. For example, system 106 can represent the cloud-based infrastructure associated with a Mobile Network Operator (MNO) or the tenant of a dedicated network (e.g., network 104), and communicates with associated network resources hosted in a private or neutral host network (e.g., network 104).

In some embodiments, cloud system 106 may include a server(s) and/or a database of information. In some embodiments, a database 108 of cloud system 106 may store a set of data and/or metadata associated with network information related to the components and/or the users (e.g., UEs 102) of system 100. In addition, database 108 may store information (e.g., video content, embeddings, similarity metrics, LLMs, and the like) used by a management engine 200, which corresponds to the novel functionality described herein.

In some embodiments, cloud system 106 can provide a private/proprietary management platform for network 104 and other devices/platforms operating thereon, and further host and/or communicate with management engine 200.

According to some embodiments, database 108 may correspond to a data storage for a platform (e.g., a network hosted platform, such as cloud system 106) or a plurality of platforms. Database 108 may receive storage instructions/requests from, for example, management engine 200 (and associated microservices), which may be in any type of known or to be known format, such as, for example, standard query language (SQL). Database 108 may correspond to any type of known or to be known storage, for example, a memory or memory stack of a device, a distributed ledger of a distributed network (e.g., blockchain, for example), a look-up table (LUT), and/or any other type of secure data repository.

Management engine 200, as discussed above and further below in more detail, can include components for the disclosed functionality. According to some embodiments, management engine 200 may be a special-purpose machine or processor within cloud system 106, or hosted by a device (or component) on network 104. In some embodiments, management engine 200 may be hosted by a server and/or set of servers associated with cloud system 106.

According to some embodiments, management engine 200 may be configured to implement and/or control a plurality of services and/or microservices, where each of the plurality of services/microservices are configured to execute a plurality of workflows associated with performing the disclosed estimation of backhaul bandwidth and private core capacity. Non-limiting embodiments of such workflows are provided below.

According to some embodiments, management engine 200 may function as an application provided by and/or hosted on network 104 (e.g., any UE and/or node as discussed below in relation to FIG. 1B) and/or by cloud system 106. In some embodiments, management engine 200 can be embodied as an application executing on UE 102 (e.g., downloaded and/or web-based execution, for example). In some embodiments, management engine 200 may function as an application installed on a server(s), network location and/or other type of network resource associated with cloud system 106 and/or network 104. In some embodiments, management engine 200 may be configured and/or installed as an augmenting script, program or application (e.g., a plug-in or extension) to another application or program provided by cloud system 106 and/or network 104 that is executed over network 104 and/or on UE 102.

Turning to FIG. 1B, illustrated is an example hybrid 5G-Ad hoc network architecture demonstrating the bandwidth management functionality provided by the disclosed framework. FIG. 1B depicts a cellular infrastructure integrated with an ad hoc mesh network topology, where multiple communication paths and potential congestion points are evident.

FIG. 1B includes a 5G cell tower 150 serving as the primary network access point, providing high-bandwidth connectivity to the broader network infrastructure. This tower connects directly to gateway nodes: 154 and 156, and via gateway node 165, to gateway node 158, which facilitates communication between the cellular infrastructure and the ad hoc network segment (180, as in FIG. 1B). Accordingly, nodes 154, 156, and 158 serve as ingress points, distributing network traffic from the centralized cellular infrastructure into the decentralized ad hoc portion of the network.

Within the ad hoc network segment (delineated by the dashed circle 180), nodes 160, 162 and 164 represent critical junction points that experience significant traffic convergence. These nodes constitute a bottleneck in the network architecture where bandwidth demands frequently exceed available capacity. The topology shows how multiple data streams from devices (e.g., UEs 170, 172, 174, 176, 178) can converge at such nodes, creating potential congestion scenarios that traditional admission control mechanisms traditionally struggle to manage proactively. As provided herein and discussed in more detail below, the disclosed framework can function to predict and configure the network, traffic, connections, requests, and/or some combination thereof, to mitigate and/or prevent such bottlenecks.

As in FIG. 1B, nodes 160 and 162 each receive traffic from multiple sources—node 160 accepts connections from node 158 and UE 174, while node 162 handles traffic from UEs 176, 178 and 172. This traffic concentration pattern creates asymmetrical load distribution across the network. FIG. 1B further illustrates how such bottleneck nodes must process and forward this aggregated traffic to additional nodes including node 164, which further connects to sink nodes 166 and 168 that serve as terminal points for data flows within the provided network segment.

As above, UEs 170, 172, 174, 176, 178 can represent various mobile devices generating dynamic traffic patterns based on user activity. UEs 170 and 174 connect directly to node 160, while UEs 172, 176 and 178 connect to bottleneck node 162, which connects to node 164 (which UE 172 connects as well), further intensifying the congestion risk at these critical junctions. This arrangement demonstrates how unpredictable user behavior can lead to sudden bandwidth demand fluctuations that propagate through the network hierarchy.

Accordingly, as provided below, the disclosed framework is configured to implement DI-based bandwidth forecasting operations to address congestion at bottleneck nodes within an Ad Hoc network. As discussed below, by analyzing historical traffic patterns, current network conditions, user movement trajectories, and the like, the framework can anticipate bandwidth availability at critical junctions and proactively adjust admission control policies before congestion materializes. Such predictive, network-based capability enables dynamic traffic routing through alternative paths when congestion is predicted, maintaining network performance during high-demand periods and ensuring consistent quality of service across all connected UEs.

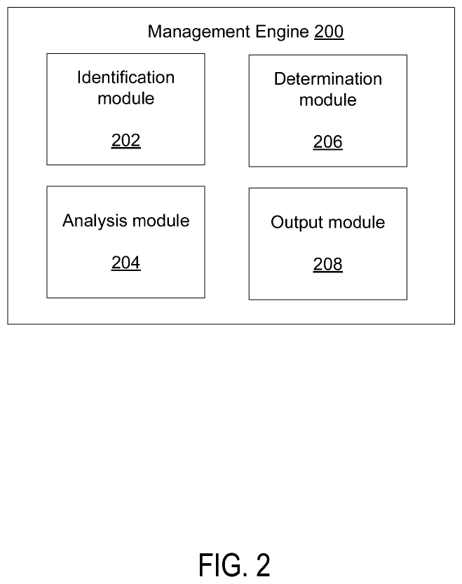

As illustrated in FIG. 2, according to some embodiments, management engine 200 includes identification module 202, analysis module 204, determination module 206 and output module 208. It should be understood that the modules discussed herein are non-exhaustive, as additional or fewer modules (or sub-modules) may be applicable to the embodiments of the systems and methods discussed. More detail of the operations, configurations and functionalities of management engine 200 and each of its modules, and their role within embodiments of the present disclosure will be discussed below.

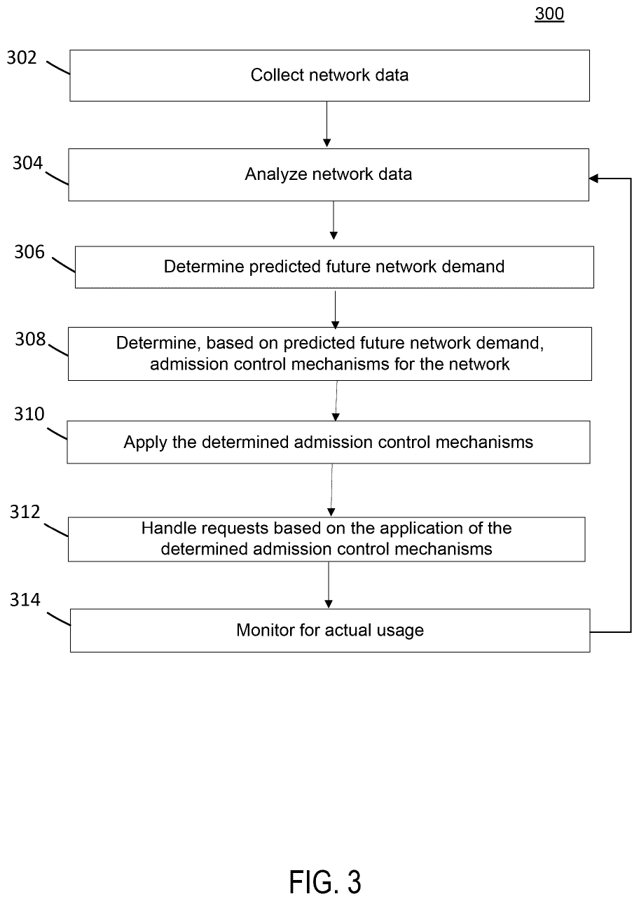

In FIG. 3, Process 300 provides non-limiting example embodiments for the DI-driven approach to network management, whereby, based on bandwidth estimations, the framework can provide network control mechanisms that provide for a dynamically adaptive network that leverages such estimations. As discussed herein, for example, upon detecting a surge, the disclosed mechanisms implemented via the framework can allocate resources to high-priority communications and downgrade non-critical data to ensure critical traffic is prioritized. Thus, as discussed herein, the network efficiently handles the traffic surge, provides real-time alerts, and ensures seamless routing for UEs (e.g., devices, such as, for example, autonomous vehicles), thereby improving safety and traffic flow while minimizing packet drops and maintaining consistent service quality. Such DI-driven approach can dynamically adapt to changing network demands, improving Quality of Service (QoS) and supporting the unique requirements of hybrid 5G-Ad hoc networks—especially in critical, safety-oriented applications where delays or packet drops could have serious consequences.

According to some embodiments, Steps 302 and 314 of Process 300 can be performed by identification module 202 of management engine 200; Step 304 can be performed by analysis module 204; Steps 306 and 308 can be performed by determination module 206; and Steps 310 and 312 can be performed by output module 208.

According to some embodiments, Process 300 begins with Step 302 where engine 200 can execute network data collection protocols to acquire network telemetry for bandwidth forecasting. In some embodiments, engine 200 can implement a multi-tiered data acquisition framework that captures bandwidth metrics, traffic flow statistics, and protocol-specific parameters across all network nodes (e.g., as per FIG. 1B, discussed supra).

In some embodiments, engine 200 can employ distributed monitoring agents that continuously sample and aggregate bandwidth utilization metrics at, for example, 100 ms intervals, creating high-resolution temporal profiles of network behavior. Such agents can implement both passive traffic monitoring through packet inspection and active probing techniques such as Transmission Control Protocol (TCP) window size analysis to determine available bandwidth. In some embodiments, engine 200 can differentiate between uplink and downlink capacities, establishing baseline performance metrics for each connection type. In some embodiments, the data collection protocol can be configured to prioritize specific metadata including QoS class identifiers, traffic differentiation parameters, and application-layer protocol signatures to enable fine-grained traffic characterization.

In Step 304, engine 200 can execute a time-series-based analysis on the collected network data using a composite AI/ML forecasting model(s). In some embodiments, engine 200 can implement a dual-model prediction mechanism that leverage Holt-Winters exponential smoothing for capturing cyclical patterns and Simple Moving Average (SMA) for trend stabilization. In some embodiments, engine 200 can utilize triple exponential smoothing equations where bandwidth forecast for future time t+horizon is calculated according to the following formula:

$$\hat{y} t + h = ( ℓ t + h * bt ) * st - m + h ,$$

with [symbol] t representing level component, bt capturing trend dynamics, and st−m+h incorporating seasonal variations. In some embodiments, engine 200 can function to optimize the seasonal cycle parameter m through auto-correlation function analysis to identify dominant periodicity in traffic patterns. Concurrently, in some embodiments, engine 200 can calculate SMA using configurable (e.g., predetermined and/or dynamically determined) window sizes determined through cross-validation testing against historical data. In some embodiments, engine 200 can employ adaptive smoothing parameters where α (level smoothing) and β (trend smoothing) can be dynamically adjusted based on observed prediction errors, implementing a form of meta-learning that optimizes forecasting parameters in response to changing network conditions.

In some embodiments, such analysis in Step 304 can involve engine 200 implementing any type of known or to be known computational analysis technique, algorithm, mechanism or technology to analyze the dataset. For example, in some embodiments, engine 200 may execute and/or include a specific trained AI/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the network data, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination with any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 306, engine 200 can determine, based on the analysis in Step 304, predicted future network demand. As discussed herein, the predicted future network demand corresponds to a bandwidth bottleneck, which, for example, can be determined (or predicted) to occur when data transmission is slowed (equal to or below a threshold limit, for example) due to insufficient network capacity, which typically can occur, for example, at points/nodes/locations where multiple high-traffic data streams converge on a network link with limited throughput (as discussed in relation to FIG. 1B, supra, for example). Such congestion can correspond to sudden or anticipated spikes in network usage, such as during video streaming events, large file transfers, or coordinated cloud computing tasks, causing packet delays, increased latency, and potential data loss that can degrade overall network performance. In some embodiments, such prediction can involve engine 200 determining predictions through an ensemble approach that combines multiple forecasting models using a weighted integration formula:

$$Future Demand = λ * HW + ( 1 - λ ) * SMA .$$

In some embodiments, engine 200 can implement gradient-based optimization to continuously adjust the λ parameter by minimizing mean squared prediction error across sliding time windows. Engine 200 can apply such methodology to perform bandwidth predictions at multiple time horizons simultaneously (5-minute, 15-minute, and 1-hour forecasts, for example) to support both immediate tactical and longer-term strategic admission control decisions.

For example, with historical bandwidth measurements of 200, 210, 220, and 215 Mbps, engine 200 first calculates level and trend components through recursive application of:

$$Lt = α Yt + ( 1 - α ) ( Lt - 1 + Tt - 1 ) and Tt = β ( Lt - Lt - 1 ) + ( 1 - β ) Tt - 1.$$

With α=0.5 and β=0.5, this iterative computation yields L4=222.5 and T4=10.625, producing a Holt-Winters forecast of 233.125 Mbps. The engine then calculates a 3-point SMA of 215 Mbps, and with λ=0.5, generates a final composite forecast of 224.0625 Mbps for the target interval.

In Step 308, engine 200 can determine, based on the predicted future network demand, admission control mechanisms (e.g., configures, policies, routing, and the like). In some embodiments, engine 200 can employ a stochastic capacity model that represents future bandwidth availability as a probability distribution rather than a point estimate, enabling risk-calibrated admission decisions. In some embodiments, engine 200 can calculate the probability of congestion as P(Demand>Capacity) for each forecast horizon and implements a three-tier admission policy framework: full admission when congestion probability is below a configurable lower threshold αL (typically 0.2, for example), conditional admission with QoS constraints when probability falls between αL and upper threshold αU (typically 0.8, for example), and admission denial when congestion probability exceeds αU. In some embodiments, engine 200 can further incorporate resource reservation protocols where critical network functions receive guaranteed minimum bandwidth allocations regardless of overall network load, implementing a form of admission control that preserves essential service functionality even during predicted congestion periods.

Accordingly, in some embodiments, such predictions can involve accepting admission of a network request/connection by a UE (e.g., when total current demand is less than or equal to available bandwidth), accepting with de-prioritization (e.g., when total demand is less than available bandwidth, and below or equal to a threshold level (e.g., total demand*total bandwidth=threshold), and denying admission (e.g., when the total demand is above the threshold level). Such calculations of total demand and threshold level values are provided above as per the analysis and determinations in Steps 304-308.

In Step 310, engine 200 can activate and apply the determined admission control mechanisms through direct integration with Software-Defined Networking (SDN) controllers and policy enforcement points. In some embodiments, engine 200 can generate OpenFlow rule sets that implement bandwidth allocation decisions through dynamic adjustment of token bucket parameters in traffic shapers and modifying queue weights in weighted fair queuing systems. In some embodiments, engine 200 can translate admission control decisions into specific technical parameters including Committed Information Rate (CIR), Maximum Burst Size (MBS), and precedence values for different traffic classes. In some embodiments, engine 200 can utilize hierarchical policy structures where macro-level network policies are decomposed into specific per-node, per-interface, and per-flow control parameters based on topological position and forecast congestion patterns.

In Step 312, engine 200 can execute predictive queue management using a custom-designed algorithm that incorporates both current queue states and forecasted bandwidth availability. Such operation enables engine 200 to handle requests (e.g., real-time and/or queued) via the admission control mechanisms. In some embodiments, engine 200 can implement a modified Weighted Random Early Detection (WRED) algorithm where drop probability thresholds are dynamically adjusted based on forecasted congestion patterns rather than just current queue depths. In some embodiments, engine 200 can preemptively modify Active Queue Management (AQM) parameters including minimum threshold, maximum threshold, and maximum drop probability in response to predicted bandwidth shortages. In some embodiments, engine 200 can apply differential packet scheduling where time-sensitive traffic flows receive prioritized forwarding when the forecasting model indicates imminent congestion, implementing a form of temporal load balancing that shifts delay-tolerant traffic to predicted low-utilization periods.

In Step 314, engine 200 can implement a closed-loop learning system with continuous model validation and refinement. Such closed-loop approach can enable the collection and analysis of the actual usage of the network via Step 312, whereby potential traffic routing and/or bottleneck handling can be performed via the recursive operation of Process 300 from Step 314 to Step 304, as illustrated in FIG. 3.

In some embodiments, engine 200 can employ a dual-time-scale evaluation framework where short-term accuracy is assessed using Mean Absolute Percentage Error (MAPE) for 5-minute forecasts while long-term model drift is monitored through cumulative Kullback-Leibler divergence between predicted and observed bandwidth distributions. In some embodiments, engine 200 can maintain parallel ensemble models with different hyperparameter configurations and periodically reweights them based on their predictive performance. In some embodiments, engine 200 can implement automatic feature importance analysis using permutation techniques to identify which network metrics provide the strongest predictive signals, allowing the data collection system to adaptively focus on the most informative parameters. Such continuous learning mechanism enables the forecasting system to maintain accuracy despite evolving network traffic patterns, changing application profiles, and infrastructure modifications.

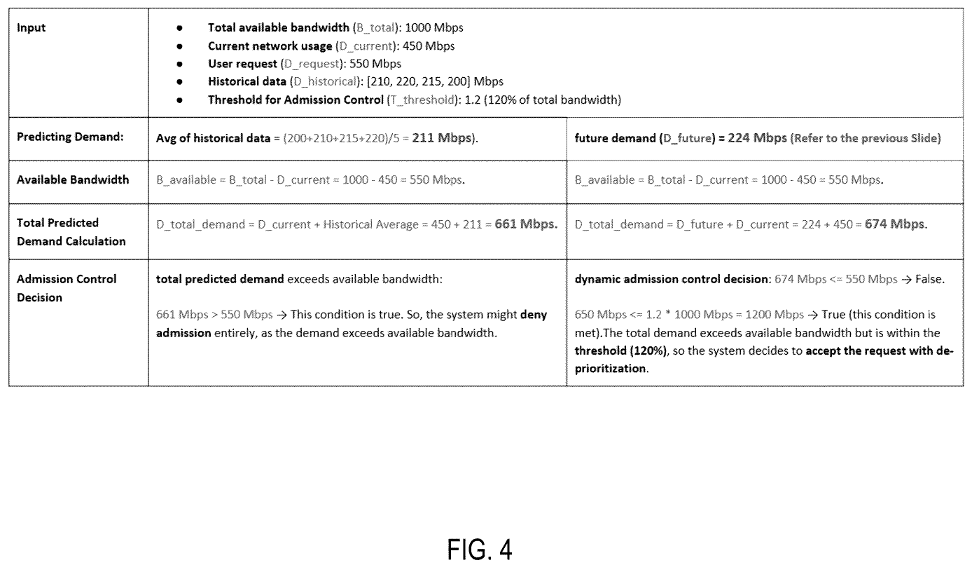

Accordingly, as discussed above respective at least FIG. 3 and in examples in FIG. 4, infra the disclosed framework is configured to optimize network bandwidth management through predictive analytics and intelligent decision-making. The framework operates by assessing incoming user requests based on real-time network conditions and forecasted demand, thereby ensuring efficient resource allocation while preventing congestion. Accordingly, as per the steps of Process 300, discussed supra, operations of the framework begin collecting network data, including, but not limited to, current usage, user requests, historical trends, and the like. In some embodiments, to enhance decision-making, the framework determines and leverages the determined future demand forecasting, discussed supra, to predict future bandwidth demand. Such functionality can integrate, for example, historical patterns with real-time inputs to provide improved accuracy in predictions of network load, thereby allowing proactive adjustments to admission decisions.

Accordingly, in some embodiments, such predictions can be utilized to perform admission control decisions. For example i) if bandwidth is sufficient, requests can be accepted without restriction; ii) if demand exceeds available bandwidth, but remains within a manageable threshold, requests can be accepted with de-prioritization to maintain service quality; and iii) if demand surpasses a critical threshold, requests can be denied to prevent network overload and degradation.

In some embodiments, the disclosed systems and methods can include functionality for priority-based scheduling for queued requests, thereby ensuring that high-priority traffic is managed efficiently. In some embodiments, to maintain accuracy, AI models utilized by the framework can be monitored and updated, which can occur continuously, such that whenever prediction errors exceed acceptable limits, the framework can function accordingly.

Therefore, by incorporating the disclosed novel demand forecasting algorithm, the framework not only optimizes bandwidth allocation, but also enhances overall network stability, thereby minimizing service disruptions, and providing an improved user experience.

FIG. 4 depicts a comparative analysis between traditional control systems and the disclosed, DI-based admission control mechanisms for network bandwidth management (as discussed above, at least respective to Process 300 of FIG. 3). In the traditional approach (left column of the table in FIG. 4), a system implements a rigid decision framework that denies admission when predicted demand exceeds available bandwidth. Specifically, such conventional model calculates a total predicted demand of 661 Mbps (combining current usage of 450 Mbps with a historical average of 211 Mbps) against available bandwidth of 550 Mbps, resulting in automatic rejection of the user request. This static methodology fails to incorporate advanced forecasting techniques or adaptive threshold management, potentially leading to unnecessary service denials.

In contrast, the proposed DI-driven approach (left column in the table of FIG. 4) employs predictive modeling to forecast a more accurate future demand of 224 Mbps, yielding a total demand of 674 Mbps. While this still exceeds the available bandwidth of 550 Mbps, the framework intelligently applies a configurable threshold parameter (120% of total bandwidth, or 1200 Mbps) to make a more nuanced decision. This flexibility allows the framework to accept the request with de-prioritization rather than outright denial, maximizing resource utilization while maintaining service availability. Thus, the disclosed framework's AI/ML model's dynamic learning capabilities enable it to continuously refine its forecasting accuracy through feedback loops, resulting in progressively improved admission control decisions over time, as discussed supra.

Accordingly, as discussed herein, the framework can operate to mitigate, configure, stop and/or modify network traffic, connections, requests and/or policies to avoid any network degradation that the framework predicted to ensure network stability during demand surges can be handled while ensuring fair resource allocation among users.

FIG. 5 is a block diagram of an example network architecture according to some embodiments of the present disclosure. In the illustrated embodiment, UE 102 accesses a data network 508 via an access network 504 and a core network 506.

In the illustrated embodiment, the access network 504 comprises a network allowing network communication with UE 102. In general, the access network 504 includes at least one base station that is communicatively coupled to the core network 506 and coupled to zero or more UE 102.

In some embodiments, the access network 504 comprises a cellular access network, for example, a 5G network. In an embodiment, the access network 504 can include a NextGen Radio Access Network (NG-RAN). In an embodiment, the access network 504 includes a plurality of next Generation Node B (e.g., eNodeB and gNodeB) base stations connected to UE 102 via an air interface. In one embodiment, the air interface comprises a New Radio (NR) air interface. For example, in a 5G network, individual user devices can be communicatively coupled via an X2 interface.

In the illustrated embodiment, the access network 504 provides access to a core network 506 to UE 102. In the illustrated embodiment, the core network may be owned and/or operated by a network operator (NO) and provides wireless connectivity to UE 102. In the illustrated embodiment, this connectivity may comprise voice and data services.

At a high-level, the core network 506 may include a user plane and a control plane. In one embodiment, the control plane comprises network elements and communications interfaces to allow for the management of user connections and sessions. By contrast, the user plane may comprise network elements and communications interfaces to transmit user data from UE 102 to elements of the core network 506 and to external network-attached elements in a data network 508 such as the Internet.

In the illustrated embodiment, the access network 504 and the core network 506 are operated by a NO. However, in some embodiments, the networks (504, 506) may be operated by a private entity and may be closed to public traffic. For example, the components of the network 506 may be provided as a single device, and the access network 504 may comprise a small form-factor base station. In these embodiments, the operator of the device can simulate a cellular network, and UE 102 can connect to this network similar to connecting to a national or regional network.

In some embodiments, the access network 504, core network 506 and data network 508 can be configured as a MEC network, where MEC or edge nodes are embodied as each UE 102 and are situated at the edge of a cellular network, for example, in a cellular base station or equivalent location. In general, the MEC or edge nodes may comprise UEs that comprise any computing device capable of responding to network requests from another UE 102 (referred to generally for example as a client) and is not intended to be limited to a specific hardware or software configuration of a device.

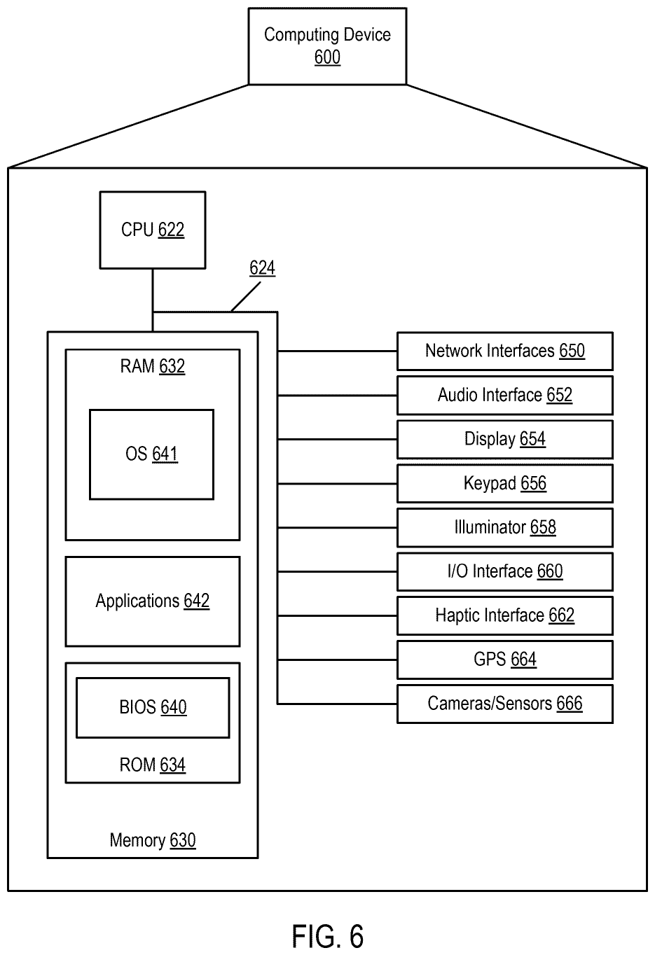

FIG. 6 is a block diagram illustrating a computing device showing an example of a client or server device used in the various embodiments of the disclosure.

The computing device 600 may include more or fewer components than those shown in FIG. 6, depending on the deployment or usage of the device 600. For example, a server computing device, such as a rack-mounted server, may not include audio interfaces 652, displays 654, keypads 656, illuminators 658, haptic interfaces 662, GPS receivers 664, or cameras/sensors 666. Some devices may include additional components not shown, such as graphics processing unit (GPU) devices, cryptographic co-processors, artificial intelligence (AI) accelerators, or other peripheral devices.

As shown in FIG. 6, the device 600 includes a CPU 622 in communication with a mass memory 630 via a bus 624. The computing device 600 also includes one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal, or electromagnetic sensors 666. Device 600 can include one camera/sensor 666 or a plurality of cameras/sensors 666. The positioning of the camera(s)/sensor(s) 666 on the device 600 can change per device 600 model, per device 600 capabilities, and the like, or some combination thereof.

In some embodiments, the CPU 622 may comprise a general-purpose CPU. The CPU 622 may comprise a single-core or multiple-core CPU. The CPU 622 may comprise a system-on-a-chip (SoC) or a similar embedded system. In some embodiments, a GPU may be used in place of, or in combination with, a CPU 622. Mass memory 630 may comprise a dynamic random-access memory (DRAM) device, a static random-access memory device (SRAM), or a Flash (e.g., NAND Flash) memory device. In some embodiments, mass memory 630 may comprise a combination of such memory types. In one embodiment, the bus 624 may comprise a Peripheral Component Interconnect Express (PCIe) bus. In some embodiments, the bus 624 may comprise multiple busses instead of a single bus.

Mass memory 630 illustrates another example of computer storage media for the storage of information such as computer-readable instructions, data structures, program modules, or other data. Mass memory 630 stores a basic input/output system (“BIOS”) 640 for controlling the low-level operation of the computing device 600. The mass memory also stores an operating system 641 for controlling the operation of the computing device 600.

Applications 642 may include computer-executable instructions which, when executed by the computing device 600, perform any of the methods (or portions of the methods) described previously in the description of the preceding Figures. In some embodiments, the software or programs implementing the method embodiments can be read from a hard disk drive (not illustrated) and temporarily stored in RAM 632 by CPU 622. CPU 622 may then read the software or data from RAM 632, process them, and store them to ROM 634.

The computing device 600 may optionally communicate with a base station (not shown) or directly with another computing device. Network interface 650 is sometimes known as a transceiver, transceiving device, or network interface card (NIC).

The audio interface 652 produces and receives audio signals such as the sound of a human voice. For example, the audio interface 652 may be coupled to a speaker and microphone (not shown) to enable telecommunication with others or generate an audio acknowledgment for some action. Display 654 may be a liquid crystal display (LCD), gas plasma, light-emitting diode (LED), or any other type of display used with a computing device. Display 654 may also include a touch-sensitive screen arranged to receive input from an object such as a stylus or a digit from a human hand.

Keypad 656 may comprise any input device arranged to receive input from a user. Illuminator 658 may provide a status indication or provide light.

The computing device 600 also comprises an input/output interface 660 for communicating with external devices, using communication technologies, such as USB, infrared, Bluetooth™, or the like. The haptic interface 662 provides tactile feedback to a user of the client device.

The optional GPS transceiver 664 can determine the physical coordinates of the computing device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS, or the like, to further determine the physical location of the computing device 600 on the surface of the Earth. In one embodiment, however, the computing device 600 may communicate through other components, providing other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special-purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
collecting network data for a time period of activity on a network;
analyzing the network data, and determining predicted network demand, the predicted network demand comprising information related to a predicted future network bandwidth bottleneck;
determining based on the predicted network demand, admission control mechanisms, the admission control mechanisms comprising functionality for handling requests for at least one node on the network that is predicted to be subject the predicted bandwidth bottleneck; and
activating the admission control mechanisms on the network, the activation causing a network configuration that mitigates the predicted bandwidth bottleneck from occurring.

2. The method of claim 1, further comprising:
handling a network request via the activated admission control mechanisms.

3. The method of claim 2, further comprising the network request corresponding to one of a queued request or a real-time request, wherein, for the real-time request, the handling occurs at a future time.

4. The method of claim 1, wherein the analysis further comprises:
analyzing, by an application executing a time-series behavior model, the network data; and
analyzing, by the application executing a moving average model, the network data.

5. The method of claim 4, wherein the time-series behavior model is a Holt Winters model and the moving average model is a Simple Moving Average (SMA) model.

6. The method of claim 1, wherein the admission control mechanisms comprises at least one of admission of a request, de-prioritization of a request, or denial of request.

7. The method of claim 1, wherein the time period includes a current time, related to network traffic, of at least one connected device to the network.

8. The method of claim 1, further comprising an application executing on at least one node on the network for performing the activation, wherein the application is trained based on information related to the determined predicted network demand and the activation of the admission control mechanisms.

9. A system comprising:
a processor configured to:
collect network data for a time period of activity on a network;
analyze the network data, and determine predicted network demand, the predicted network demand comprising information related to a predicted future network bandwidth bottleneck;
determine based on the predicted network demand, admission control mechanisms, the admission control mechanisms comprising functionality for handling requests to at least one node on the network that is predicted to be subject the predicted bandwidth bottleneck; and
activate the admission control mechanisms on the network, the activation causing a network configuration that mitigates the predicted bandwidth bottleneck from occurring.

10. The system of claim 9, wherein the processor is further configured to:
handle a network request via the activated admission control mechanisms.

11. The system of claim 10, wherein the processor is further configured such that the network request corresponds to one of a queued request or a real-time request, wherein, for the real-time request, the handling occurs at a future time.

12. The system of claim 9, wherein the processor is further configured to:
analyze, by an application executing a time-series behavior model, the network data; and
analyze, by an application executing moving average model, the network data.

13. The system of claim 12, wherein the processor is further configured such that the time-series behavior model is a Holt Winters model and the moving average model is a Simple Moving Average (SMA) model.

14. The system of claim 9, wherein the processor is further configured such that the admission control mechanisms comprises at least one of admission of a request, de-prioritization of a request, or denial of request.

15. The system of claim 9, wherein the processor is further configured such that the time period includes a current time related to network traffic of at least one connected device to the network.

16. A non-transitory computer-readable storage medium tangibly encoded with computer-executable instructions, that when executed by a device, perform a method comprising:
collecting network data for a time period of activity on a network;
analyzing the network data, and determining predicted network demand, the predicted network demand comprising information related to a predicted future network bandwidth bottleneck;
determining based on the predicted network demand, admission control mechanisms, the admission control mechanisms comprising functionality for handling requests to at least one node on the network that is predicted to be subject the predicted bandwidth bottleneck; and
activating the admission control mechanisms on the network, the activation causing a network configuration that mitigates the predicted bandwidth bottleneck from occurring.

17. The non-transitory computer-readable storage medium of claim 16, further comprising:
handling a network request via the activated admission control mechanisms.

18. The non-transitory computer-readable storage medium of claim 17, further comprising the network request corresponding to one of a queued request or a real-time request, wherein, for the real-time request, the handling occurs at a future time.

19. The non-transitory computer-readable storage medium of claim 16, wherein the analysis further comprises:
analyzing, by an application executing a time-series behavior model, the network data; and
analyzing, by an application executing moving average model, the network data.

20. The non-transitory computer-readable storage medium of claim 16, further comprising the admission control mechanisms comprise at least one of admission of a request, de-prioritization of a request, or denial of request.
